(19) United States
(12) Patent Application Publication
(10) Pub. No.: US 2011/0060993 A1
(43) Pub. Date: Mar. 10, 2011

(54) Interactive Detailed Video Navigation System

(75) Inventors: Lawrence Cotter, Austin, TX (US); Thomas Huguley, Cedar Park, TX (US)

(73) Assignee: CLASSIFIED VENTURES, LLC, Chicago, IL (US)

(21) Appl. No.: 12/876,777

(22) Filed: Sep. 7, 2010

Related U.S. Application Data
(60) Provisional application No. 61/240,595, filed on Sep. 8, 2009.

(51) Int. Cl. G06F 3/01

(52) U.S. Cl. 715/720

(57) ABSTRACT

An interactive video within a content hosting website may appear to be a complete GUI. The interactive video may include both a static wrapper UI with interactive features including buttons, links to internal and external information, and dynamically updated text, and a video portion within the wrapper. The interactive video may be a single, annotated video file that includes dynamic links to periodically updated and dynamically updated information. For example, when the interactive video is an apartment finding service, if a community updates information within a database, the corresponding text information within the annotated areas of the interactive video may automatically update and replace the old information on the video.

PRIORITY INFORMATION

This application claims the benefit of U.S. Patent Provisional Application No. 61/240,595 filed Sep. 8, 2009, entitled “Interactive Detailed Video Navigation System” and is entirely incorporated by reference herein.

### TECHNICAL FIELD

The present disclosure generally relates to a system and method for presenting dynamic, interactive information, and, more particularly, to displaying interactive information in a single digital video file that presents both a video portion and a wrapper portion, the wrapper including selectable areas for presenting annotations within a content hosting system for the video file.

### BACKGROUND

Several Internet services permit the upload and display of disparate user video content to a central web hosting service that may then be accessed and played on any web-enabled device that connects to the host service. For example, the YouTube™ hosting service (a service of YouTube, LLC located in San Bruno, Calif.) permits users to upload video content that may be accessed and displayed on web-enabled devices (e.g., personal computers, cellular phones, smart phones, web-enabled televisions, etc.). Users that post the content to YouTube™ are permitted to edit the originally-posted content, however, other users cannot. One method of editing the original content is called “annotation” in which, at any point in the timeline of the video, a posting user may add text or other content to portions of the video image. Video annotations generally allow a posting user to add interactive commentary onto posted videos. The posting user controls what the annotations say, where they appear on the video, what action a user must take to activate the annotation, and when the annotations appear, disappear, activate and deactivate. Additionally, the posting user can link from an annotation to another video within the hosting service, an external URL, or a search result within the service. For example, in addition to text information that is displayed on the video according to the progression of the timeline, a posting user may insert “links” to other URLs that permit a viewing user to exit the video and view other information. The capability to annotate web-hosted videos has permitted posting users to greatly enhance the amount of information that is available to the viewing user.

However, these annotated videos only appear as traditional video information to the viewing user. While the annotated videos progress naturally from a beginning point to and end point in the video, and the annotated information is available to the user at various times as configured by the posting user, nothing about the annotated video guides the user through the viewing process or compels the user to select and view additional content that the posting user may add by annotation, or provides an interactive, website-like experience that guides the user toward finding more information about a particular subject.

### SUMMARY

An interactive video within a content hosting website may appear to be a complete GUI. The interactive video may include both a static wrapper UI with interactive features including buttons, links to internal and external information, and dynamically updated text, and a video portion within the wrapper. The interactive video may be a single, annotated video file that includes dynamic links to periodically updated and dynamically updated information. For example, when the interactive video is an apartment finding service, if a community updates information within a database, the corresponding text information within the annotated areas of the interactive video may automatically update and replace the old information on the video.

In one embodiment, an interactive detailed video navigation system for configuring and displaying a digital video file on a web-enabled device comprises a program memory, a processor, an interactive video production engine, and a video annotation engine. The interactive video production engine may include instructions stored in the program memory and executed by the processor to: receive a digital video file including a timeline, an image, and a video; receive an overlay graphic template including a video area and a graphic area, the graphic area including a plurality of graphic elements; combine the digital video file and the overlay graphic into a flattened video file; and send a web request to a content hosting system interface communicatively connected to the interactive video producer, the web request to store the flattened video in a data warehouse of the content hosting system. The video annotation engine may include instructions stored in the program memory and executed by the processor to cause the content hosting system to store a plurality of annotations, each annotation corresponding to a graphic element, an image, or a video of the flattened video file and each annotation including a beginning time and an ending time corresponding to a portion of the timeline. Each annotation may be active from the beginning time to the ending time. During playback of the flattened video file, the digital video file may be displayed within the video area and the graphic area may be displayed at least partially surrounding the video area. Interactive information may be displayed in the flattened video upon activation of an annotated graphic element, image, or video.

In a further embodiment, a computer-readable medium may store computer-executable instructions to be executed by a processor on a computer of an interactive video producer. The instructions may be for producing an interactive video file appearing as a graphical user interface and comprise: receiving a digital video file including a timeline, an image, and a video; receiving an overlay graphic template including a video area and a graphic area, the graphic area including a plurality of graphic elements; combining the digital video file and the overlay graphic into a flattened video file; sending a web request to a content hosting system interface communicatively connected to the interactive video producer, the web request to store the flattened video in a data warehouse of the content hosting system; and causing the content hosting system to store a plurality of annotations, each annotation corresponding to a graphic element, an image, or a video of the flattened video file and each annotation including a beginning time and an ending time corresponding to a portion of the timeline. Each annotation may be active from the beginning time to the ending time. During playback of the flattened video file, the digital video file may be displayed within the video area and the graphic area may be displayed at least partially surrounding the video area. Interactive information may be displayed in the flattened video upon activation of an annotated graphic element, image, or video.

In a still further embodiment, a method for producing an interactive video file that appears as a graphical user interface may comprise: receiving a digital video file including a timeline, an image, and a video; receiving an overlay graphic template including a video area and a graphic area, the graphic area including a plurality of graphic elements; combining the digital video file and the overlay graphic into a flattened video file; sending a web request to a content hosting system interface communicatively connected to the interactive video producer, the web request to store the flattened video in a data warehouse of the content hosting system; and causing the content hosting system to store a plurality of annotations, each annotation corresponding to a graphic element, an image, or a video of the flattened video file and each annotation including a beginning time and an ending time corresponding to a portion of the timeline. Each annotation may be active from the beginning time to the ending time. During playback of the flattened video file, the digital video file may be displayed within the video area and the graphic area may be displayed at least partially surrounding the video area. Interactive information may be displayed in the flattened video upon activation of an annotated graphic element, image, or video.

### BRIEF DESCRIPTION OF THE DRAWINGS

FIG. 1A illustrates a block diagram of a computer network and system on which an exemplary interactive detailed video navigation system and method may operate in accordance with the described embodiments;

FIG. 1B illustrates a block diagram of a computer network and an exemplary interactive video producer system upon which various methods to produce an interactive video to be hosted on a content hosting system may operate in accordance with the described embodiments;

FIG. 1C illustrates a block diagram of a data warehouse for storing various information related to an interactive video in accordance with the described embodiments;

FIG. 2 illustrates an exemplary block diagram of a flow chart for one embodiment of a method for creating one or more video files for display within a video portion of the interactive detailed video navigation system;

FIG. 3A illustrates an exemplary block diagram of a flow chart for one embodiment of a method for creating one or more overlay graphics for display within a graphic user interface portion of the interactive detailed video navigation system;

FIG. 3B illustrates an exemplary overlay graphic for display within an interactive video in accordance with the described embodiments;

FIG. 4A illustrates an exemplary block diagram of a flow chart for one embodiment of a method for combining the one or more overlay graphics and the one or more videos into a video file;

FIG. 4B illustrates a screen shot of one exemplary video file;

FIG. 5A illustrates an exemplary block diagram of a flow chart for one embodiment of a method for uploading the combined video file to a digital resource hosting service and annotating the combined video file creating a first video for display within a video portion of the interactive detailed video navigation system; and

FIG. 5B illustrates an exemplary screen shot of an interactive detailed video navigation system.

### DETAILED DESCRIPTION

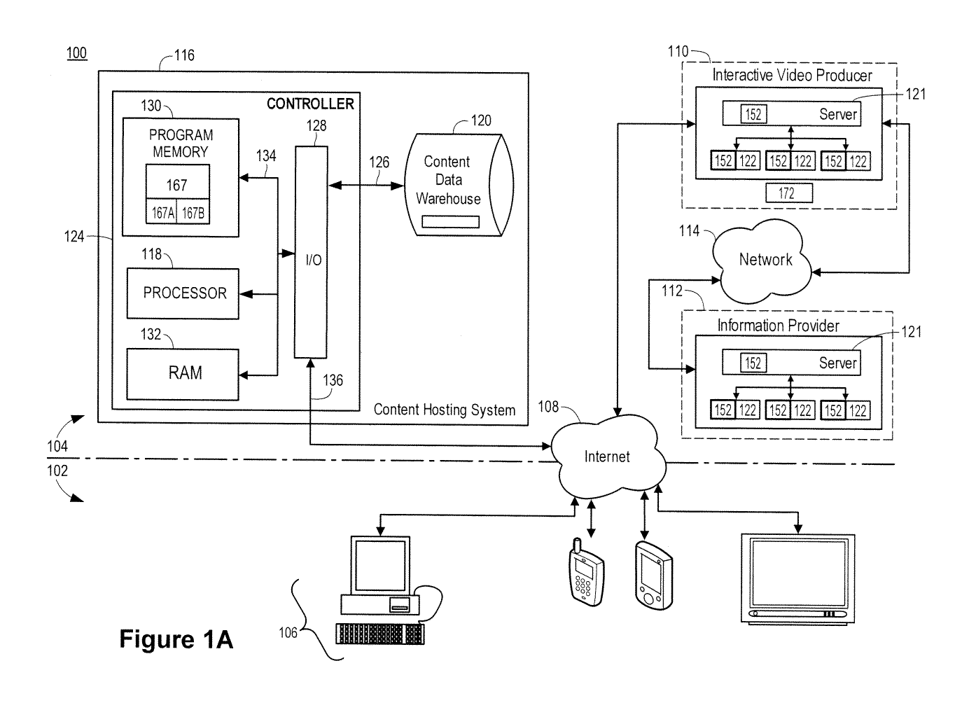

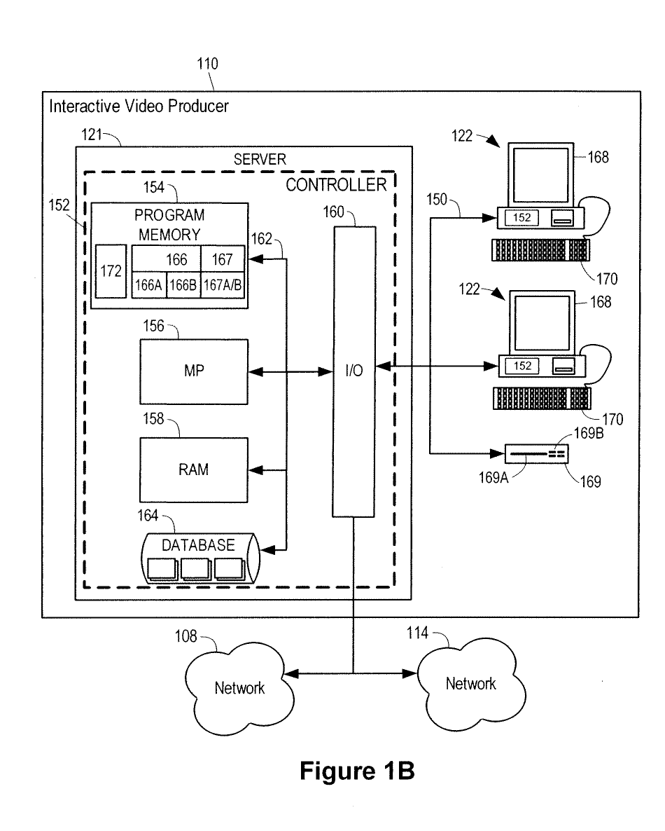

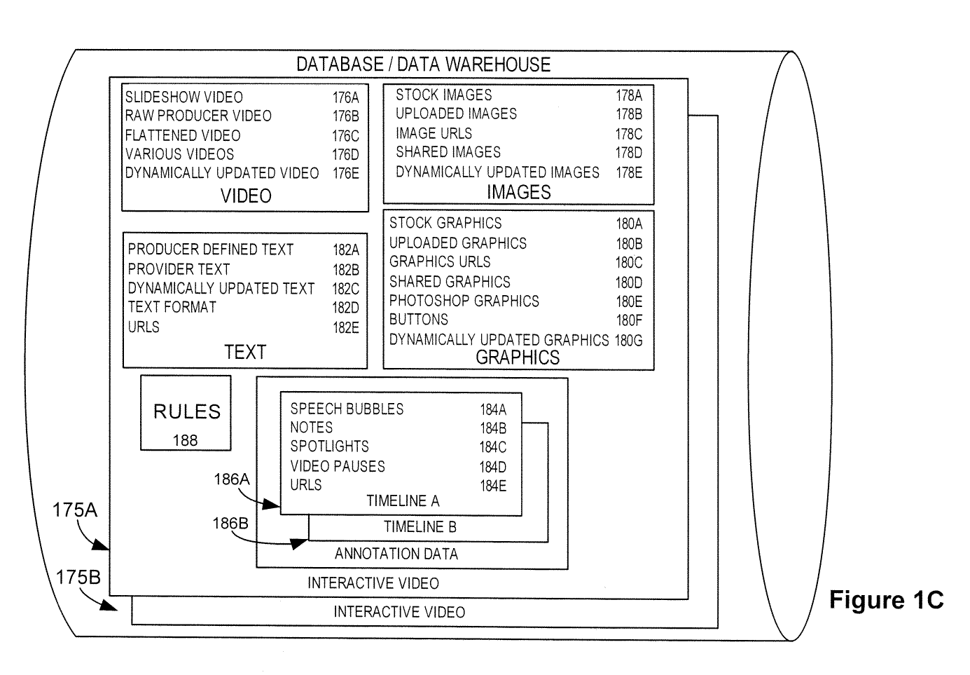

FIG. 1 illustrates various aspects of an exemplary architecture implementing an interactive detailed video navigation system 100. In particular, FIG. 1 illustrates a block diagram of the exemplary interactive detailed video navigation system 100. The high-level architecture includes both hardware and software applications, as well as various data communications channels for communicating data between the various hardware and software components. The interactive detailed video navigation system 100 may be roughly divided into front-end components 102 and back-end components 104. The front-end components 102 are primarily web-enabled devices 106 (personal computers, smart phones, PDAs, televisions, etc.) connected to the internet 108 by one or more users. The web-enabled devices 106 may be located, by way of example rather than limitation, in separate geographic locations from each other, including different areas of the same city, different cities, or even different states.

The front-end components 102 communicate with the back-end components 104 via the Internet or other digital network 108. One or more of the front-end components 102 may be excluded from communication with the back-end components 104 by configuration or by limiting access due to security concerns. For example, the web-enabled devices 106 may be excluded from access to the particular back-end components such as the interactive video producer 110 and the information provider 112, as further described below. In some embodiments, the web-enabled devices 106 may communicate with the back-end components via the Internet 108. In other embodiments, the web-enabled devices 106 may communicate with the back-end components 104 via the same digital network 108, but digital access rights, IP masking, and other network configurations may deny access of the devices 106 to the back-end components 104.

The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol. The back-end components 104 include a content hosting system 116 such as YouTube™ or other internet-based, publicly-accessible system. Alternatively, the content hosting system may be private or may be a secure LAN. In some embodiments, the content hosting system 116 may be wholly or partially owned and operated by the interactive video producer 110 or any other entity. The content hosting system 116 may include one or more computer processors 118 adapted and configured to execute various software applications, modules, and components of the interactive detailed video navigation system 100 that, in addition to other software applications, allow a producer to annotate content posted to the system by the interactive video producer 110, as further described below. The content hosting system 116 further includes a data warehouse or database 120. The data warehouse 120 is adapted to store content posted by various users of the content hosting system 116, such as the interactive video producer 110, and data related to the operation of the content hosting system 116, the users (e.g., annotation data and any other data from the interactive video producers, information providers, etc.) and the interactive detailed video navigation system 100. The content hosting system 116 may access data stored in the data warehouse 120 when executing various functions and tasks associated with the operation of the interactive detailed video navigation system 100, as described herein.

Although the interactive detailed video navigation system 100 is shown to include a content hosting system 116 in communication with three web enabled devices 106, an interactive video producer 110 and an information provider 112, it should be understood that different numbers of processing systems, computers, users, producers, and providers may be utilized. For example, the Internet 108 or network 114 may interconnect the system 100 to a plurality of content hosting systems, other systems 110, 112, and a vast number of web-enabled devices 106. According to the disclosed example, this configuration may provide several advantages, such as, for example, enabling near real-time updates of information from the information provider(s) 112, changes to the content from the interactive video producer 110, as well as periodic uploads and downloads of information by the interactive video producer(s) 110. In addition to the content data warehouse 120, a content video producer 110 may store content locally on a server 121 and/or a workstation 122.

FIG. 1 also depicts one possible embodiment of the content hosting system 116. The content hosting system 116 may have a controller 124 operatively connected to the data warehouse 120 via a link 126 connected to an input/output (I/O) circuit 128. It should be noted that, while not shown, additional databases or data warehouses may be linked to the controller 124 in a known manner.

The controller 124 includes a program memory 130, the processor 118 (may be called a microcontroller or a microprocessor), a random-access memory (RAM) 132, and the input/output (I/O) circuit 128, all of which are interconnected via an address/data bus 134. It should be appreciated that although only one microprocessor 118 is shown, the controller 124 may include multiple microprocessors 118. Similarly, the memory of the controller 124 may include multiple RAMs 132 and multiple program memories 130. Although the I/O circuit 128 is shown as a single block, it should be appreciated that the I/O circuit 128 may include a number of different types of I/O circuits. The RAM(s) 132 and the program memories 139 may be implemented as a computer-readable storage memory such as one or more semiconductor memories, magnetically readable memories, and/or optically readable memories, for example. A link 136 may operatively connect the controller 124 to the digital network 108 through the I/O circuit 128.

FIG. 1B depicts one possible embodiment of the interactive video producer 110 located in the “back end” as illustrated in FIG. 1A. Although the following description addresses the design of the interactive video producer 110 and information provider 112, it should be understood that the design of the producer 110 and provider 112 may be different than the design of others of the producer 110 or provider 112. Also, the interactive video producer 110 may have various different structures and methods of operation. It should also be understood that while the embodiment shown in FIG. 1B illustrates some of the components and data connections that may be present in an interactive video producer 110 or information provider 112, it does not illustrate all of the data connections that may be present in an interactive video producer 110 or information provider 112. For exemplary purposes, one design of an interactive video producer 110 is described below, but it should be understood that numerous other designs may be utilized.

The interactive video producer 110 may have one or more workstations 122 and/or a server 121. The digital network 150 operatively connects the server 121 to the plurality of workstations 122. The digital network 150 may be a wide area network (WAN), a local area network (LAN), or any other type of digital network readily known to those persons skilled in the art. The digital network 150 may also operatively connect the server 121 and the workstations 122 to the content hosting system 116.

Each workstation 122 and server 121 includes a controller 152. Similar to the controller 124 from FIG. 1A, the controller 152 includes a program memory 154, a microcontroller or a microprocessor (MP) 156, a random-access memory (RAM) 158, and an input/output (I/O) circuit 160, all of which are interconnected via an address/data bus 162. In some embodiments, the controller 152 may also include, or otherwise be communicatively connected to, a database 164. The database 164 (and/or the database/content warehouse 120 of FIG. 1A) includes data such as video files, digital images, text, a database that is dynamically linked to an information provider 112 for real-time updates, annotation data, etc. As discussed with reference to the controller 152, it should be appreciated that although FIG. 1B depicts only one microprocessor 156, the controller 152 may include multiple microprocessors 156. Similarly, the memory of the controller 152 may include multiple RAMs 158 and multiple program memories 154. Although the figure depicts the I/O circuit 160 as a single block, the I/O circuit 160 may include a number of different types of I/O circuits. The controller 152 may implement the RAM(s) 158 and the program memories 154 as semiconductor memories, magnetically readable memories, and/or optically readable memories, for example.

Each workstation 122 and the server 121 may also include or be operatively connected to a removable, non-volatile memory device 169 to access computer-readable storage memories. The non-volatile memory device 169 may include an optical or magnetic disc reader 169A, a USB or other serial device ports 169B, and other access to computer-readable storage memories. In some embodiments, the interactive video production engine 166 may be stored on a computer-readable memory that is accessible by the non-volatile memory device 169 so that modules 166A, 166B and instructions may be temporarily transferred to the program memory 154 and controllers 160, 152 for execution by a processor 156, as described herein.

The program memory 154 may also contain an interactive video production engine 166, and the program memory 130 may also contain a video annotation engine 167, for execution within the processors 156 and 118 (FIG. 1A), respectively. The interactive video production engine 166 may perform the various tasks associated with the production of a digital interactive video. The engine 166 may be a single module 166 or a plurality of modules 166A, 166B and include instructions stored on a computer-readable storage medium (e.g., RAM 158, program memory 154, a removable non-volatile memory 169, etc), to implement the methods and configure the systems and apparatus as described herein. While the engine 166 is depicted in FIG. 1B as including two modules, 166A and 166B, the engine 166 may include any number of modules to produce an interactive video as described herein. By way of example and not limitation, the interactive video production engine 166 or the modules 166A and 166B within the interactive video production engine 166 may include instructions to: create a video or slideshow from one or more images, videos, and other media objects, receive a video or slideshow including one or more images, videos, and other media, create and edit an overlay graphic template for the interactive video, receive and edit an overlay graphic template for the interactive video, create and edit a video for display in a portion of the overlay graphic template, receive and edit a video for display in a portion of the overlay graphic template, upload a video including the overlay and the video onto a content hosting system, facilitate annotation of the uploaded video using the video annotation engine 167 of the content hosting system 116, and configure the annotated video for dynamic updating of text, video, or other data associated with the video that may be received from an information provider 112. The interactive video production engine 166 and/or each of the modules 166A, 166B may include the instructions described above and the instruction of the interactive video production methods described below that are stored in memory and executed by a processor 156 with reference to FIGS. 1-6.

In addition to the controller 152, the workstations 122 may further include a display 168 and a keyboard 170 as well as a variety of other input/output devices (not shown) such as a scanner, printer, mouse, touch screen, track pad, track ball, isopoint, voice recognition system, digital camera, etc. An employee or user of the interactive video producer may sign on and occupy each workstation 122 as a “producer” to produce an interactive video.

Various software applications resident in the front-end components 102 and the back-end components 104 implement the interactive video production methods and provide various user interface means to allow users (i.e., production assistants, graphic designers, information providers, producers, etc.) to access the system 100. One or more of the front-end components 102 and/or the back-end components 104 (e.g., the interactive video producer 110) may include various video, image, and graphic design applications 172 allowing a user, such as the interactive video production assistant or graphic designer, to input and view data associated with the system 100, and to complete an interactive video for display through the content hosting system 116. For example, the user interface application 172 may be a web browser client for accessing various distributed applications for producing an interactive video as herein described. Additionally, the application(s) 172 may be one or more image, video, and graphic editing applications such as Animoto™ (produced by Animoto Productions based in New York, N.Y.), the Final Cut™ family of applications (produced by Apple, Inc of Cupertino, Calif.), and Photoshop™ (produced by Adobe Systems, Inc. of San Jose, Calif.), to name only a few possible applications 172. However, the application 172 may be any type of application, including a proprietary application, and may communicate with the various servers 121 or the content hosting system 116 using any type of protocol including, but not limited to, file transfer protocol (FTP), telnet, hypertext-transfer protocol (HTTP), etc. The information sent to and from the workstations 122, the servers 121, and/or the content hosting system 116 includes data retrieved from the data warehouse 120 and/or the database 164. The content hosting system 116 and/or the servers 121 may implement any known protocol compatible with the application 172 running on the workstations 122 and adapted to the purpose of editing, producing, and configuring an interactive video as herein described.

As described above, one or both of the databases 120 and 164, illustrated in FIGS. 1A and 1B, respectively, include various interactive data elements 177 related to the interactive video as well as annotation information and update configuration information including, but not limited to, information associated with third-party information providers 112, videos 176, images 178, text content 182, graphics 180, annotations data 186, URLs or other links to external data, data source information, update information, and the like. FIG. 1C depicts some of the exemplary data that the system 100 may store on the databases 120 and 164. The databases 120 and/or 164 contain video files 176 for interactive videos 175. Each of the videos 176 may include other data from the data warehouse, as well. For example, an Animoto™ video 176A may include one or more images 178 that, when formatted, produce a “slideshow” type video. Further, the videos 178 may include links to other resources, for example, a URL to an image, another video, or other source of data. Further, the videos 176 may include raw video 176B from any source, a previously formatted V3 video 176C (as described below), or other videos 176D. The videos 176 may also include dynamically updated videos 176E that may be provided by an information provider 112 or other source and updated automatically after the completed interactive video 175 is posted to the content hosting system 116. Dynamic updates to any of the data within the data warehouse 120 and/or database 164 may be made via a remote database and update module at the video producer 110 or the information provider 112.

Image data 178 may include stock images 178A provided by the content hosting system 116, the producer 110, information provider 112 or other source, uploaded images 178B that an entity has stored within the database, URLs or other links to images 178C, and shared images 178D that other users have designated as available for other videos or uses within the content hosting system 116. The images 178 may also include dynamically updated images 178E that may be provided by an information provider 112 or other source and updated automatically after the completed interactive video 175 is posted to the content hosting system. As with the dynamically updated video 176E, the dynamically updated images 178E may be updated through access to a remote database at the video producer 110 or the information provider 112.

The database may also include graphics 180 that may or may not be specifically produced for display within an interactive video 175, as described herein. For example, stock graphics 180A may be provided by the system 100 for use within any portion of an interactive video 175, uploaded graphics 180B that an entity has stored within the database, URLs or other links to graphics 180C, shared images 180D that other users have designated as available for other videos or uses within the content hosting system 116, Photoshop™ graphics 180E, buttons 180F or other interactive graphics that, when activated by a user, may display other resources within the database (e.g., other videos 176, images 178, graphics 180, text 182, etc.) when the interactive video 175 is displayed on a web-enabled device 106. As generally known in the art, the buttons may include text (some of which may serve as links and URLs to additional information, other interactive videos, or web pages), data entry boxes or text fields, pull-down lists, radio buttons, check boxes, images, and buttons. Throughout this specification, it is assumed that the buttons refer to graphic elements that a user may activate using a mouse or other pointing device. Thus, throughout the specification, the terms “click” and “clicking” may be used interchangeably with the terms “select,” “activate,” or “submit” to indicate the selection or activation of one of the buttons or other display elements. Of course, other methods (e.g., keystrokes, voice commands, etc.) may also be used to select or activate the various buttons. Moreover, throughout this specification, the terms “link” and “button” are used interchangeably to refer to a graphic representation of a command that may be activated by clicking on the command.

Text 182 may also provide information for display within the videos 176, after formatting and annotating the text 182 into an interactive video 175, as further described below. In some embodiments, the text 182 may include producer defined text 182A (e.g., text that the producer 110 provides to be placed within a completed interactive video 175), provider text 182B (e.g., text that the information provider 112 submits for the interactive video 175), dynamically updated text 182C that may be provided by an information provider 112 or other source and updated automatically after the completed interactive video 175 is posted to the content hosting system 116. The dynamically updated text 182C may be updated via access to a remote database at the video producer 110 or the information provider 112, or another source.

Annotation data 184 may include any data provided by the interactive video producer 110 to format and display any of the video 176, images 178, graphics 180, text 182, and any other information within the completed interactive video 175. The annotation data 186 may include multiple timelines 186 that correspond to different sets of annotation data 184 that are associated with a single completed interactive video 175. For example, timeline 186A may display an Animoto™ video 176A one minute after a user begins to play the interactive video 175, while timeline 186B may display the same video one minute and twenty seconds into the interactive video, or may display a Photoshop™ graphic 180E instead. Annotation data may include any type of modification permitted by the YouTube™ content hosting system using the annotation engine 167. For example, an annotation may include Speech bubbles 184A for creating pop-up speech bubbles with text 182, Notes 184B for creating pop-up boxes containing text 182, Spotlights 184C for highlighting areas in an interactive video (i.e., when the user moves a mouse over spotlighted areas, the text may appear), Video Pauses 184D for pausing the interactive video 175 for a producer-defined length of time, links or URLs 184E to speech bubbles, notes and highlights. Each of the annotations 184 may be applied to any of the video 176, images 178, text 182, graphics 180, and other items that appear within a completed interactive video 175, as further described below.

The data warehouse 120 and/or the database 164 may also include rules 188 related to the display and/or dynamic update of the information within the interactive video. In particular, the rules 188 may define how often a query is made to a server at the interactive video producer 110 or the information provider 112 to update the information (i.e., video 176, images 178, graphics 180, text 182, etc.) displayed within the interactive video, or may define a time period during which the interactive video 175 is valid. Before or after the time period, the content hosting system 116 may not allow user access to the interactive video 175 or may otherwise modify the interactive video so that a user and/or the interactive video producer 110 and/or the information provider is aware that the interactive video is not valid. The rules 188 may also define various display formats for the video, graphics, text, and image data within the hosting system 116. Of course, any other rules 188 may be defined by the producer 110 or may be defined by default to control the display of the interactive video 175 or various information updates or formats for display within the system 116.

The methods for producing and displaying an interactive video 175 may include one or more functions that may be stored as computer-readable instructions on a computer-readable storage medium, such as a program memory 130, 154, and non-volatile memory device 169 as described herein. The instructions may be included within graphic design applications 172, the interactive video production engine 166, the video annotation engine 167, and various modules (e.g., 166A, 166B, 167A, and 167B), as described above. The instructions are generally described below as “blocks” or “function blocks” proceeding as illustrated in the flowcharts described herein. While the blocks of the flowcharts are numerically ordered and described below as proceeding or executing in order, the blocks may be executed in any order that would result in the production and display of an interactive video, as described herein.

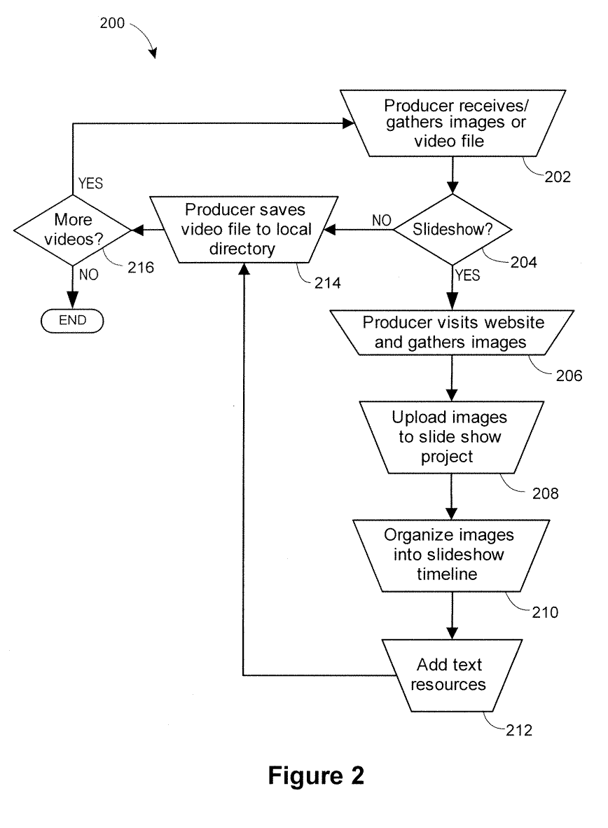

FIG. 2 illustrates one embodiment of a method 200 for creating or formatting a video 176 portion of the interactive video 175. To create a slide show 176A (e.g., an Animoto™ slide show), at block 202, a producer at the interactive video producer 110 may access the information provider 112 via the network 114 to collect several images 178 from a photo gallery or other image resource and save the images 178 to a local directory at the producer 110. Additionally or alternatively, the information provider 112 may send one or more images 178 to the producer 110. At block 204, if the producer is creating a slideshow, then, the produce may create a slide show video 176A for the images 178 (e.g., using the services provided by Animoto.com, the producer may create an Animoto™ Slideshow Video for the images 178). For example, at block 206, the producer may visit a website or other image resource for an apartment listing service (e.g., Apartmentliving.com, etc.) and, at block 208, the producer may upload the images 178 into a slide show project, at block 210, may organize the images 178 within a slideshow timeline, and, at block 212, may add one or more Text resources 182 to the images 178. The text 182 may include any information that identifies the images or provides information to a potential user, for example, an apartment complex name, city, phone, URLs for further information, etc.

Once images 178, text 182 or other resources are in place, at block 214, the producer may render the timeline to create the slideshow as a video file (e.g., a .mov file). Alternatively, if, at block 204, the producer is placing a regular video within the interactive video 175, then the method 200 proceeds to block 214 to save the video resource as a .mov file or any other video file format. If, at block 216, the producer wants to add further video files 176, then the method proceeds to block 202. If, at block 216, the producer does not want to add any further videos, then the method 200 may terminate.

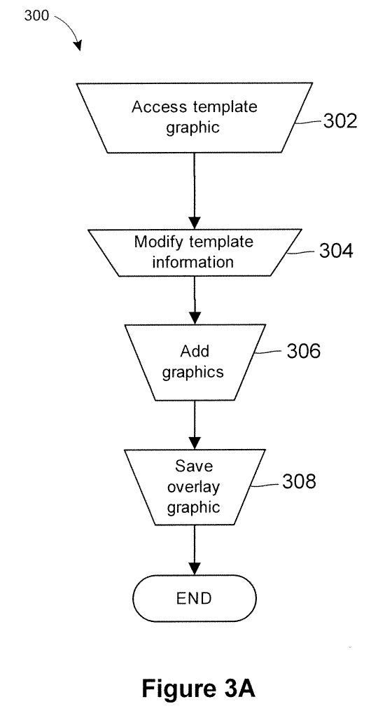

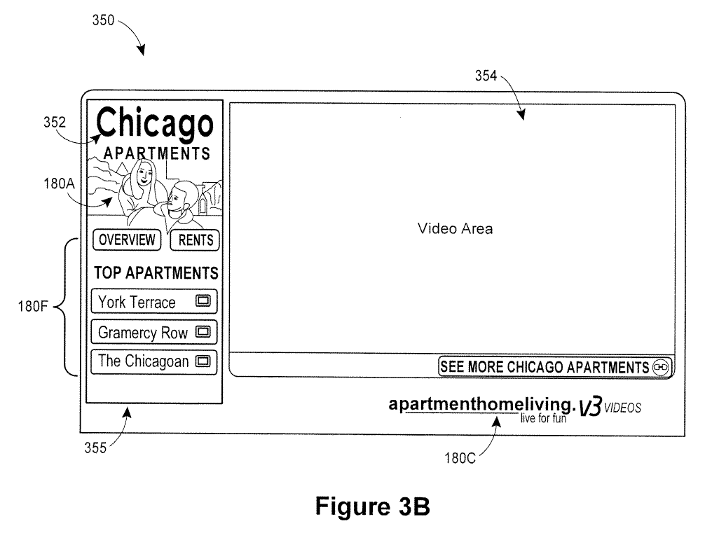

With reference to FIGS. 3A and 3B, the producer may use a method 300 to create a graphic 180 (e.g., a Photoshop™ graphic 180E) that is displayed as a “wrapper” around one or more of the videos 176 for display within the content hosting system 116. In one embodiment, the graphic 180 is an Overlay Graphic Template 350 including a Community Name/City 352, information buttons 180F, links 180C, other graphics 180A, etc. For example, at block 302, the producer may access a template or other saved graphic (e.g., 180E). At block 304, the producer may modify the information illustrated in the selected graphic 180 to match the current project. Each of the graphics 180 may be editable by the producer to display producer-defined information. At block 306, the producer may add one or more other graphics to the overlay graphic template 350 including one or more additional buttons 180F or any other graphics 180, text, 182, or other information. The overlay graphic template 350 includes a video area 354 that is formatted or may be formatted by the producer to fit the video described by the method 200. The overlay graphic template 350 also includes a graphic area 355 that displays the various graphics 180 as described herein. At block 308, the producer may save the completed overlay graphic 350 in a local directory in a known graphic format, for example, a .png file.

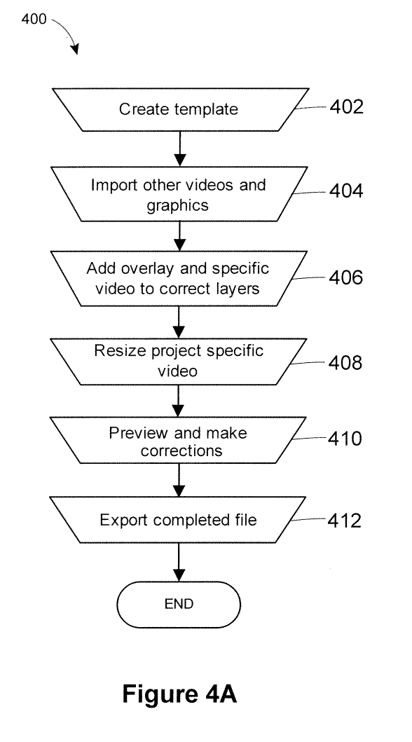

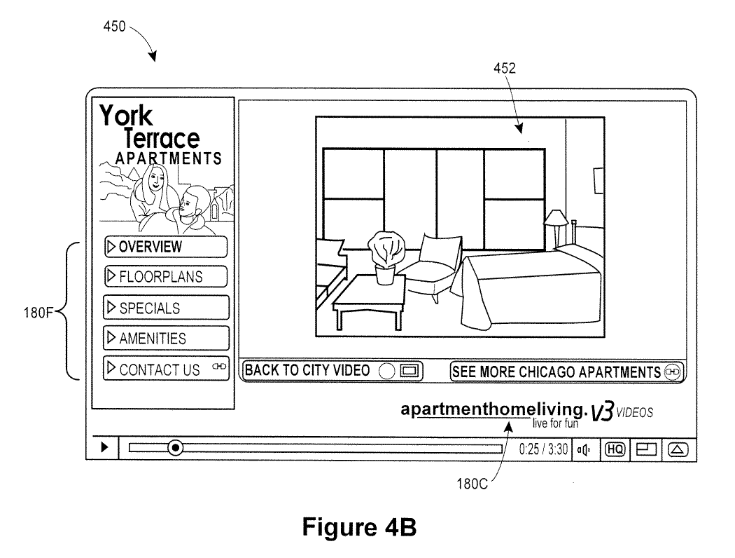

With reference to FIGS. 4A and 4B, the producer may use a method 400 to create the video file 176 that incorporates both the video created and saved using the method 200, the overlay graphic created and saved using the method 300, and other elements in a “layered” fashion to create a single, flattened video file 176 (e.g., a V3 video file 176C). Various layers may be “flattened” to create a flattened video file 176 using proprietary methods or available video editing software such as Final Edit Pro™ as previously mentioned. At block 402, the producer may create or receive an overlay graphic template 450 (FIG. 4B) that includes several layers of video content for display in the final interactive video 175 including a plurality of images 178, text 182, videos 176, and graphic elements 180. For example, one layer may include a plurality of detail button graphics 180F (e.g., Overview, Floorplans, Specials, Amenities, Contact us, etc). As further explained below, each button 180F may be a different layer of the video. Other layers may include standard video files 176 (e.g., an Outro Graphic, Intro Graphic, Stock “3D” motion video sized to fit the video area 452, etc.) including branding information, advertisements, etc. At block 404, the producer may import other video 176 and graphic elements 180 that are specific to the interactive video 175 the producer is creating. For example, the producer may import the slideshow 176A and/or the overlay graphic 350 for an apartment community where the graphic 350 was saved locally as described with reference to FIGS. 2 and 3, respectively. At block 406, the producer may place the overlay 350 and the project-specific video 176A within different layers of the interactive video 175. For example, the producer may place the graphic overlay 350 on a video layer that is above the slideshow 176A, but below the button graphics 180F.

At block 408, the producer may resize the project specific video (i.e., the slideshow video 176A) for the video area 452 within the template 450. At block 410, the producer may preview the video on a video editing application (e.g., Final Cut Pro™, etc.) and make corrections, if necessary. Finally, at block 412, the producer may export the complete video as a video file 176C (e.g., as a QuickTime .mov file) and save the file 176C to a local directory. In some embodiments, the producer may export the video 176C in a specification that conforms to the content hosting service 116. For example, a 720×405 frame size using square pixel aspect ratio, and H264 compressed at 100% quality. Of course, many other specifications may be used for the completed file 176C. At this point, the methods 200, 300, and 400 have created a flattened, non-annotated video file 176C that appears as a single, flat movie when played from start to finish. The annotation process, as described below, may add further, interactive and dynamic information to the video 176C.

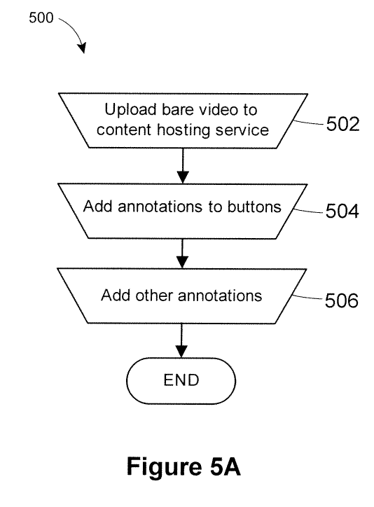

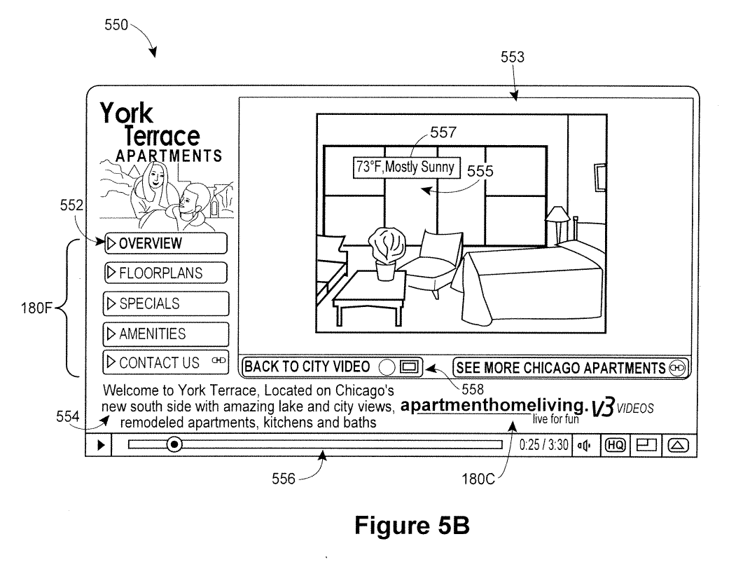

With reference to FIG. 5A, the producer may use a method 500 to annotate the flattened video file 176C. At block 502, the producer may use a content hosting service 116 (e.g., YouTube™) to upload the video 176C to the data warehouse 120. When uploading, the producer may include an optimized title, description and tag info to describe the file 176C. The content hosting service 116 may also assign a URL for the video 176C. Once uploaded, the producer may use the URL to send a web request to a server of the content hosting service 116 to access an interface for the video annotation engine 167. At block 504, the producer may use the video annotation engine 167 or other service of the content hosting service 116, or another application to add particular annotation data 184 to any portion of the flattened video 176C, for example, the buttons 180F of the various layers of the flattened video 176C. In some embodiments, the video annotation engine 167 is an interface through which the content hosting service 116 may be accessed by the interactive video producer 110. Any portion of the video 176, (e.g., buttons 180F [FIG. 5B], images, text, a window depicted within the video area 553, etc.) may be assigned annotations to provide interactive information to a user while viewing the interactive video 175. Each annotation may also be assigned a particular beginning and ending time corresponding to a portion of the video timeline 556. Each annotation may be active or selectable from the beginning time to the end time as the video 176 is played. As shown in FIG. 5B, in one embodiment, an overview detail button 552 may be annotated using a Highlight Annotation during a portion of the playback timeline of the video 176. During playback, the button 552 is highlighted around the Overview Detail Graphic 552 area on the V3 video 176C. Further, the producer may adjust a text box 554 to fit within the bottom “blank” text area on the video 176C. The interactive video production engine may also send a command to the content hosting system to store the annotations.

The producer may also insert a brief overview of subject of the video. For example, the bare video 176C may describe an apartment community and the producer may insert a brief description of that community (e.g., a brief description of York Terrace Apartments, etc.). The text inserted within the text box 554 may be any type of text 182. For example, where dynamically updated text 182C is used, the information displayed within any annotation, such as text box 554, may be dynamically linked to the information provider 112 or another source to update after the annotations are configured and stored. The dynamic resources may be updated periodically or according to one or more rules 188, as described above. For example, a window 555 may be annotated so that when a user “mouses over” the window image, another text box 557 may display dynamically updated text 182C about the weather in Chicago. If the temperature should change from 73° to 74°, text box 557 including the dynamically updated text 182C may change to reflect the current temperature of 74°. Of course, any of the annotations 184 including dynamically updated text 182C, video 176E, images 178E, and graphics 180G may change from moment to moment as the interactive video 175 is played and while the dynamic annotation is active within the playback timeline. The interactive video producer may also adjust when this dynamic information is available to the user by adjusting a time within a timeline 556 of the video 176C that the particular annotation is displayed to a user. A publish function of the video annotation engine 167 (not shown) may save the annotations 184 for the buttons 180F to the data warehouse 120. The other buttons 180F may be annotated in a similar manner as described above, and may employ dynamically updated text 182C or any other of the videos 176, images 178, text 182, and graphics 180, described herein. Any of the buttons 180F may also include URLs 183F to provide additional information to the user via an external link. Such links may be shortened if necessary using a URL shortening service, for example, bit.ly™.

At block 506, the producer may add other annotations to the video 176C and various graphic elements visible within the overlay 350. For example, a “Back to City Video” area 558 may be annotated by highlighting, erasing the default text from the text box 554 and the hide text box 554 by adjusting it (with no text) to fit at the bottom-right corner of the video 176C as small as it can be. A link to another video 176C may be added to the annotation, for example, a URL 182E to another interactive video 175 within the content hosting service 116. The URL 182E may also point to an external source, for example, a website for the publisher of the interactive video 175 (e.g., apartmenthomeliving.com) or other external source.

Once all annotations are complete and published, the interactive video 175 is saved to the data warehouse 120 of the hosting service 116 and is ready for use. When viewing the interactive video, a user may “mouse over” or otherwise activate, select or click any of the annotated areas of the video 175 as it plays within the user's browser. Each annotated area becomes a “hotspot” for the interactive video, such that further information (i.e., video 176, images 178, text 182, and graphics 180) may be displayed as the interactive video 175 is played. The text, URLs, “highlights” and other functions as annotated by the producer may then be visible to the user as he or she watches the video. Thus, the user may view what appears to be a complete GUI that includes both a static “wrapper” UI with interactive features (buttons, links to internal and external information, dynamically updated text 182C, etc.), and a video portion within the website for the content hosting service 116. Yet, the interactive video 175 is merely a single, annotated video file that may include dynamic links to periodically updated and dynamically updated information, as described herein. For example, when the interactive video 175 is an apartment finding service, if a community updates the overview, floor plan prices, or other information within a database accessed by both the publisher 110 and the provider 112, the corresponding text information within the annotated buttons may automatically update and replace the old information on the video 175.

This detailed description is to be construed as exemplary only and does not describe every possible embodiment, as describing every possible embodiment would be impractical, if not impossible. One could implement numerous alternate embodiments, using either current technology or technology developed after the filing date of this provisional patent application.

1. An interactive detailed video navigation system for configuring and displaying a digital video file on a web-enabled device, the system comprising:
a program memory;
a processor;
an interactive video production engine including instructions stored in the program memory and executed by the processor to:
receive a digital video file including a timeline, an image, and a video;
receive an overlay graphic template including a video area and a graphic area, the graphic area including a plurality of graphic elements;
combine the digital video file and the overlay graphic into a flattened video file; and
send a web request to a content hosting system interface communicatively connected to the interactive video producer, the web request to store the flattened video in a data warehouse of the content hosting system; and
a video annotation engine including instructions stored in the program memory and executed by the processor to cause the content hosting system to store a plurality of annotations, each annotation corresponding to a graphic element, an image, or a video of the flattened video file and each annotation including a beginning time and an ending time corresponding to a portion of the timeline;
wherein each annotation is active from the beginning time to the ending time, during playback of the flattened video file, the digital video file is displayed within the video area and the graphic area is displayed at least partially surrounding the video area, and interactive information is displayed in the flattened video upon activation of an annotated graphic element, image, or video.

2. The system of claim 1, wherein the video annotation engine includes instructions executed by the processor to annotate the flattened video file through an interface with the content hosting system.

3. The system of claim 1, wherein each of the plurality of annotations corresponds to an interactive data element, the interactive data element including a video, an image, text, and a graphic.

4. The system of claim 1, wherein the flattened video file includes a plurality of layers.

5. The system of claim 4, wherein the digital video file and the overlay graphic are organized within a separate layer of the flattened video file.

6. The system of claim 1, wherein an annotation corresponds to a resource outside of the content hosting system data warehouse, the resource including a dynamically updated text, video, image, or graphics and the resource changes after the content hosting system stores the plurality of annotations.

7. The system of claim 6, wherein activation of the annotated graphic element, image, or video includes activation of the resource.

8. The system of claim 7, wherein activation of the resource updates the dynamically updated text, video, image, or graphics.

9. A computer-readable medium storing computer-executable instructions to be executed by a processor on a computer of an interactive video producer, the instructions for producing an interactive video file appearing as a graphical user interface, the instructions comprising:
receiving a digital video file including a timeline, an image, and a video;
receiving an overlay graphic template including a video area and a graphic area, the graphic area including a plurality of graphic elements;
combining the digital video file and the overlay graphic into a flattened video file;
sending a web request to a content hosting system interface communicatively connected to the interactive video producer, the web request to store the flattened video in a data warehouse of the content hosting system; and
causing the content hosting system to store a plurality of annotations, each annotation corresponding to a graphic element, an image, or a video of the flattened video file and each annotation including a beginning time and an ending time corresponding to a portion of the timeline;
wherein each annotation is active from the beginning time to the ending time, during playback of the flattened video file, the digital video file is displayed within the video area and the graphic area is displayed at least partially surrounding the video area, and interactive information is displayed in the flattened video upon activation of an annotated graphic element, image, or video.

10. The computer-readable medium of claim 9, wherein the instructions further comprise sending a remote command through an interface with the content hosting system to store the flattened video file.

11. The computer-readable medium of claim 9, wherein each of the plurality of annotations corresponds to an interactive data element, the interactive data element including a video, an image, text, and a graphic.

12. The computer-readable medium of claim 9, wherein the flattened video file includes a plurality of layers.

13. The computer-readable medium of claim 12, wherein the digital video file and the overlay graphic are organized within a separate layer of the flattened video file.

14. The computer-readable medium of claim 9, wherein an annotation corresponds to a resource outside of the content hosting system data warehouse, the resource including a dynamically updated text, video, image, or graphics and the resource changes after the content hosting system stores the plurality of annotations.

15. The computer-readable medium of claim 14, wherein activation of the annotated graphic element, image, or video includes activation of the resource.

16. The computer-readable medium of claim 15, wherein activation of the resource updates the dynamically updated text, video, image, or graphics.

17. A method for producing an interactive video file appearing as a graphical user interface comprising:
receiving a digital video file including a timeline, an image, and a video;
receiving an overlay graphic template including a video area and a graphic area, the graphic area including a plurality of graphic elements;
combining the digital video file and the overlay graphic into a flattened video file;
sending a web request to a content hosting system interface communicatively connected to the interactive video producer, the web request to store the flattened video in a data warehouse of the content hosting system; and
causing the content hosting system to store a plurality of annotations, each annotation corresponding to a graphic element, an image, or a video of the flattened video file and each annotation including a beginning time and an ending time corresponding to a portion of the timeline;
wherein each annotation is active from the beginning time to the ending time, during playback of the flattened video file, the digital video file is displayed within the video area and the graphic area is displayed at least partially surrounding the video area, and interactive information is displayed in the flattened video upon activation of an annotated graphic element, image, or video.

18. The method of claim 17, wherein each of the plurality of annotations corresponds to an interactive data element, the interactive data element including a video, an image, text, and a graphic.

19. The method of claim 17, wherein an annotation corresponds to a resource outside of the content hosting system data warehouse, the resource including a dynamically updated text, video, image, or graphics and the resource changes after the content hosting system stores the plurality of annotations.

20. The method of claim 19, wherein activation of the annotated graphic element, image, or video includes activation of the resource and activation of the resource updates the dynamically updated text, video, image, or graphics.
